(19) United States
(12) Patent Application Publication
(10) Pub. No.: US 2016/0341582 A1
(43) Pub. Date: Nov. 24, 2016

(54) ELECTROMAGNETIC FLOWMETER

(71) Applicant: KABUSHIKI KAISHA TOSHIBA, Tokyo (JP)

(72) Inventors: Yunli LIM, Kawasaki Kanagawa (JP); Takuya IIJIMA, Tokyo (JP); Hiroaki NOJIRI, Kawasaki Kanagawa (JP); Satoshi HOJO, Tokyo (JP)

(21) Appl. No.: 15/100,933

(22) PCT Filed: Apr. 9, 2014
(86) PCT No.: PCT/JP2014/060301

§ 371 Date: Jun. 1, 2016

(30) Foreign Application Priority Data
Dec. 2, 2013 (JP) 2013-249599

(51) Int. Cl. G01F 1/58

(52) U.S. Cl. CPC G01F 1/586

(57) ABSTRACT

According to an embodiment, an electromagnetic flowmeter according to an embodiment includes a pipe, a pair of base members, and coil units. A fluid to be measured flows through the pipe. The pair of base members each includes a first portion and at least one second portion. The pair of base members is provided across an axial center of the pipe. The first portion contacts with an outer face of the pipe. The second portion protrudes from the first portion toward outside of the pipe radially. Coil units each includes a cylindrical coil. The coil units correspond to the second portions and attached to the base members while the second portions are inserted into pipes of the coils. The coil units have a same specification as a specification of coil units of another electromagnetic flowmeter that includes the pipe having a different outer diameter.

### FIELD

Embodiments of the present invention relate to an electromagnetic flowmeter.

### BACKGROUND

Conventionally, electromagnetic flowmeters are known, which include coils having different specifications in accordance with different outer diameters of pipes.

### CITATION LIST

### Patent Literature

Patent Literature 1: Japan Laid-open Patent Publication No. 2001-281028

### SUMMARY OF THE INVENTION

### Problem to be Solved by the Invention

It is desirable to realize such an electromagnetic flowmeter with a novel configuration that enables a reduction in the manufacturing costs, as an example.

### Means for Solving Problem

An electromagnetic flowmeter according to an embodiment comprises a pipe, a pair of base members, and coil units. A fluid to be measured flows through the pipe. The pair of base members each includes a first portion and at least one second portion. The pair of base members is provided across an axial center of the pipe. The first portion contacts with an outer face of the pipe. The second portion protrudes from the first portion toward outside of the pipe radially. Coil units each includes a cylindrical coil. The coil units correspond to the second portions and attached to the base members while the second portions are inserted into pipes of the coils. The coil units have a same specification as a specification of coil units of another electromagnetic flowmeter that includes the pipe having a different outer diameter.

### BRIEF DESCRIPTION OF DRAWINGS

FIG. 1 is a perspective view of an example of an electromagnetic flowmeter according to a first embodiment.

FIG. 2 is a cross-sectional view of FIG. 1 along the II-II line.

FIG. 3 is a cross-sectional view of FIG. 2 along the line.

FIG. 4 is a cross-sectional view of an example of a detector included in another electromagnetic flowmeter according to the first embodiment.

FIG. 5 is a cross-sectional view of FIG. 4 along the V-V line.

FIG. 6 is a cross-sectional view of an example of a detector included in an electromagnetic flowmeter according to a second embodiment.

FIG. 7 is a cross-sectional view of FIG. 6 along the VII-VII line.

FIG. 8 is a cross-sectional view of an example of a detector included in another electromagnetic flowmeter according to the second embodiment.

FIG. 9 is a cross-sectional view of FIG. 8 along the IX-IX line.

FIG. 10 is a cross-sectional view of an example of a detector included in an electromagnetic flowmeter according to a third embodiment.

FIG. 11 is a cross-sectional view of FIG. 10 along the XI-XI line.

FIG. 12 is a cross-sectional view of an example of a detector included in an electromagnetic flowmeter according to a fourth embodiment.

FIG. 13 is a cross-sectional view of FIG. 12 along the XIII-XIII line.

### DETAILED DESCRIPTION

Exemplary embodiments will be described below with reference to the accompanying drawings. The following embodiments include same or like constituent elements, hence, the same or like constituent elements are given common reference numerals, and a redundant explanation is omitted. Moreover, the following embodiments will illustrate examples of configurations (technical features) as well as action and effects resulting from the configurations. The present invention can also be implemented by different configurations other than the configurations disclosed in the following embodiments, and the present invention can achieve various effects (including consequential effects) obtained by the fundamental configuration (technical features).

### First Embodiment

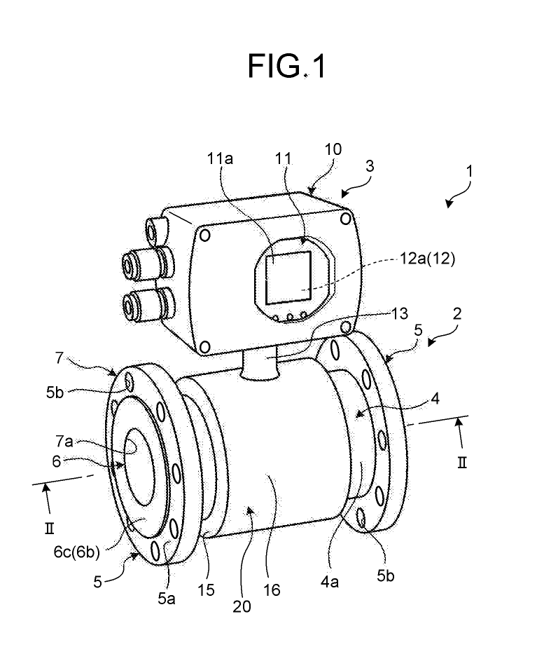

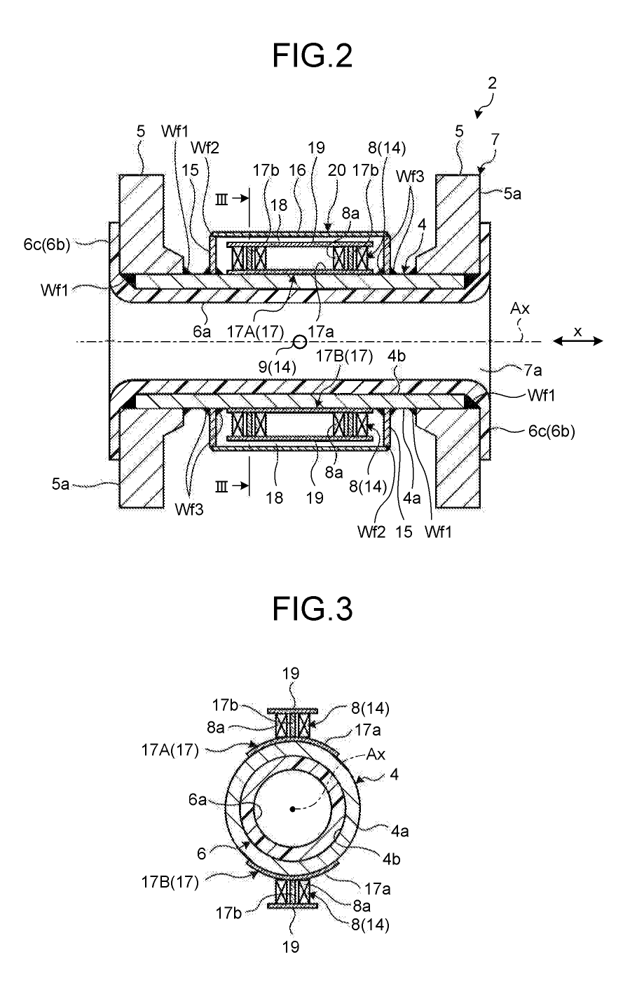

In the present embodiment, as an example, as illustrated in FIG. 1, an electromagnetic flowmeter 1 (a first electromagnetic flowmeter) includes a detector 2 and a converter 3 (a display device or an electronic device). The detector 2 includes a pipe 7 having an internal flow channel 7a and includes a detecting element 14 (see FIG. 2) that detects a fluid to be measured while flowing through the flow channel 7a. The detecting element 14 includes a pair of electrodes 9, 9 for contacting with the fluid to be measured (in FIG. 2, only a single electrode 9 is illustrated), and includes at least one pair (in the first embodiment, as an example, two pairs) of coil units 8, 8 that generate a magnetic field. The line connecting the pair of electrodes 9, 9 is substantially orthogonal to an axial center Ax (see FIGS. 2 and 3) of the pipe 7 (a measurement pipe 4). The pairs of coil units 8, 8 generate a magnetic field in the direction orthogonal to the line connecting the pair of electrodes 9, 9 and the axial center Ax. The converter 3 includes a housing 10 accommodating a display 12, and a controller (not illustrated). The converter 3 is fixed to the detector 2 via a coupler 13. The coupler 13 includes a wiring (a harness or a cord) via which the converter 3 (the controller) and the detector 2 (the detecting element 14) are electrically connected.

In the electromagnetic flowmeter 1, a magnetic field is generated inside the pipe 7 by the pairs of coil units 8. A flow of the fluid to be measured orthogonal to the magnetic field causes generation of an electromotive force in the direction orthogonal to the magnetic field and the fluid to be measured. The electromotive force from the fluid is detected by the pair of electrodes 9, 9. Then, the pair of electrodes 9, 9 transmits a detection signal corresponding to the electromotive force to the controller of the converter 3. The controller calculates (detects) a magnitude (value) of the electromotive force from the detection signal. Moreover, the controller calculates a flow rate from the calculated magnitude of the electromotive force and displays the flow rate on the display 12 (a display screen 12a). Herein, for example, the electromagnetic flowmeter 1 can be configured as a normal excitation type (alternating-current excitation type) electromagnetic flowmeter.

The display 12 includes the display screen 12a and is supported in the housing 10 in such a manner that the display screen 12a is viewable. In the first embodiment, as an example, the display 12 is contained in the housing 10 and covered with a panel 11. The panel 11 has a transparent (for example, colorless and transparent) cover member 11a (a transmissive member, a translucent member, or a window) disposed thereon. The display screen 12a of the display 12 is viewed through the covering member 11a. The display 12 is a liquid crystal display (LCD), for example.

As an example, as illustrated in FIGS. 1 and 2, the pipe 7 includes the measurement pipe 4 (pipe), flanges 5, a lining 6, and a case 20. The pipe 7 can be coupled with another pipe (a pipe to be measured, not illustrated) through which the fluid to be measured flows. The detecting element 14 and the controller detect the flow rate of the fluid to be measured from the another pipe into the pipe 7.

As an example, the measurement pipe 4 has a tubular shape (in the first embodiment, as an example, a cylindrical shape) along the axis of the pipe 7 (axial center, X direction, see FIG. 2). The measurement pipe 4 has an outer face 4a (outer periphery, outside face, face opposite the flow channel 7a, or a first face) and an inner face 4b (inner periphery, inside face, face on flow channel 7a side, or a second face). The case 20 and the flanges 5 are provided on the outer face 4a of the measurement pipe 4 while the pair of electrodes 9 and the lining 6 are provided on the inner face 4b of the measurement pipe 4. As an example, the measurement pipe 4 can be made from a nonmagnetic material such as SUS (stainless steel).

As an example, the flanges 5 have a circular shape (in the first embodiment, as an example, annular shape) along the outer face 4a of the measurement pipe 4. The flanges 5 are, for example, secured (joined) with the outer face 4a of the measurement pipe 4 by welding. Moreover, the flanges 5 are provided at both axial (X direction) ends of the measurement pipe 4. The pair of flanges 5, 5 may be simply referred to as the flange 5 when they do not need to be discriminated.

The flange 5 has an end face 5a (a face or a joint face) with which an object to join (a flange of another pipe coupled with the pipe 7) is overlapped or which opposes the object. Moreover, the flange 5 includes a plurality of holes 5b (mount holes) that pass through the flange 5 along the axis (X direction). As illustrated in FIG. 1, the holes 5b are provided at a constant spacing (any spacing; in the first embodiment, as an example, at spacing of 45° around the axial center) along the circumference of the flange 5 at a plurality (any number) of positions (in the first embodiment, as an example, eight positions in total). Fasteners (such as bolts, not illustrated) are inserted into the holes 5b for joining the pipe 7 with the object (the flange of another pipe coupled with the pipe 7). As an example, the flange 5 can be made from a metallic material such as SUS (stainless steel).

The lining 6 includes, as an example, a tubular portion 6a (a first portion) and flare portions 6b (second portions). The tubular portion 6a is tubular (in the first embodiment, as an example, cylindrical) along the inner face 4b of the measurement pipe 4, and covers the inner face 4b. The inner face of the tubular portion 6a forms the flow channel 7a. The flare portions 6b are circular (in the first embodiment, as an example, plate-like and annular) along the end faces 5a of the flanges 5, and cover the end faces 5a. The flare portions 6b are provided at both axial ends (X direction) of the tubular portion 6a, and project as a flange in a direction intersecting with (in the first embodiment, as an example, orthogonal to) the axial direction (X direction). Moreover, as an example, the flare portions 6b can cover the end faces 5a from the inner periphery (inside ends or radial inner ends) to middle points to the outer periphery (outside ends or radial outer ends). That is, in the first embodiment, the flare portions 6b cover the end faces 5a from the inner periphery to points before the holes 5b, and thus the holes 5b are left opened.

Meanwhile, each flare portion 6b has an end face 6c which opposes the end face of the flange 5 and forms the outer face of the pipe 7. The lining 6 extends across the measurement pipe 4 and the flanges 5, for example. The tubular portion 6a and the flare portions 6b of the lining 6 protect the inner face 4b of the measurement pipe 4 and the end faces 5a of the flanges 5. The lining 6 can be made from a synthetic resin material such as fluorine contained resin.

The case 20 has end walls 15 (wall portions, or first cover members) and a peripheral wall 16 (a wall portion, a cover, a cover member, or a second cover member), for example. The pair of end walls 15 are provided with a spacing along the axis (X direction) of the measurement pipe 4, and extend as a flange in a direction intersecting with the axis (X direction) (in the first embodiment, as an example, orthogonal direction). The peripheral wall 16 is located at the outer periphery of the end walls 15 (at the end opposite the measurement pipe 4), and extends in a direction intersecting with the end walls 15 (in the first embodiment, as an example, orthogonal direction or axial direction of the measurement pipe 4). The peripheral wall 16 is has a tubular shape (in the first embodiment, as an example, a cylindrical shape) along the outer face 4a of the measurement pipe 4. The peripheral wall 16 extends between the pair of end walls 15 and is secured (joined) onto the outer periphery of the end walls 15 by welding, for example. The inner periphery of the end walls 15 (the end on the measurement pipe 4 side or the end opposite the peripheral wall 16) is secured (joined) onto the outer face 4a of the measurement pipe 4 by welding, for example. Thus, the case 20 is attached to the measurement pipe 4.

The case 20 houses the coil units 8, base members 17 (yoke members or core members), and outer members 19 (support members or hold members). Thus, the coil units 8, the base members 17 and the outer members 19 are disposed in the space between the outer face 4a of the measurement pipe 4 and (the inner face of) the peripheral wall 16. The peripheral wall 16 is placed lateral to the coil units 8, opposing the measurement pipe 4, and covers the coil units 8 along the outer face 4a of the measurement pipe 4. The members of the detector 2 can be welded at welding positions Wf1 to Wf3.

The base members 17 are made from, for example, a magnetic material such as iron and steel or a silicon steel sheet. The base members 17 are disposed on both sides (both vertical sides) of the measurement pipe 4 across the axial center A (see FIGS. 2 and 3). Thus, The base members 17 include a first base member 17A and a second base member 17B which oppose each other across the measurement pipe 4. The pair of base members 17A and 17B may be simply referred to as the base member 17 when they do not need to be discriminated.

Each base member 17 includes a first portion 17a and a second portion 17b. As an example, as illustrated in FIG. 3, as viewed from the axial direction (X direction) along the axial center Ax, the first portion 17a has an arc-like shape along the outer face 4a of the measurement pipe 4. For example, the first portion 17a is secured (joined) on the outer face 4a of the measurement pipe 4 by welding. The second portion 17b protrudes outward from the first portion 17a in a radial direction of the measurement pipe 4. For example, the second portion 17b can be secured (joined) with the first portion 17a by welding or with fasteners.

As an example, each coil unit 8 includes a cylindrical coil 8a (an exciting coil). The coil unit 8 can be formed, for example, by hardening, by impregnation, a copper wire (the coil 8a) cylindrically wound a certain (any) number of times. With the second portion 17b inserting into the pipe of the coil 8a, the coil unit 8 is attached to the base member 17. In the first embodiment, the coil unit 8 is configured of only the cylindrical coil 8a. Alternatively, for example, the coil unit 8 can be configured of a cylindrical coil bobbin and a coil wound around the coil bobbin.

As illustrated in FIGS. 2 and 3, as an example, the outer members 19 have a flat plate-like shape (a thin plate-like shape). The outer members 19 are provided corresponding to the first base member 17A and the second base member 17B, and placed lateral to the coil units 8, opposing the first portion 17a. For example, The outer members 19 can be secured (joined) onto the corresponding second portions 17b by welding or with fasteners. Each coil unit 8 is located between the first portion 17a and the outer member 19. Thus, the outer members 19 can prevent the coil units 8 from falling out radially outside. The coil units 8 are one example of support members for the outer members 19.

The magnetic field (magnetic flux) generated inside the coil units 8 (the second portions 17b) spreads along the outer face 4a of the measurement pipe 4 due to the first portion 17a. The spread magnetic field (magnetic flux) then flows across inside the measurement pipe 4 from the first portion 17a of one of the base members 17 (for example, the first base member 17A) toward the first portion 17a of the other base member 17 (for example, the second base member 17B). According to the first embodiment, by the arc-like first portions 17a along the outer face 4a, the flow of magnetic field (magnetic flux) can easily spread widely inside the measurement pipe 4. Hence, as an example, the magnetic flux density can be easily increased inside the measurement pipe 4.

Moreover, in the first embodiment, as an example, a plurality of (in the first embodiment, as an example, two) second portions 17b are provided on each first portion 17a with a gap along the axis of the measurement pipe 4 (X direction). Moreover, the coil units 8 are attached to the second portions 17b, respectively. Thus, according to the first embodiment, as an example, the generated magnetic field (magnetic flux) can easily increase inside the measurement pipe 4 through the first portions 17a. Note that the coil units 8 have the same specifications. That is, in the plurality of second portions 17b, the coil units 8 representing identical components (common components) are used.

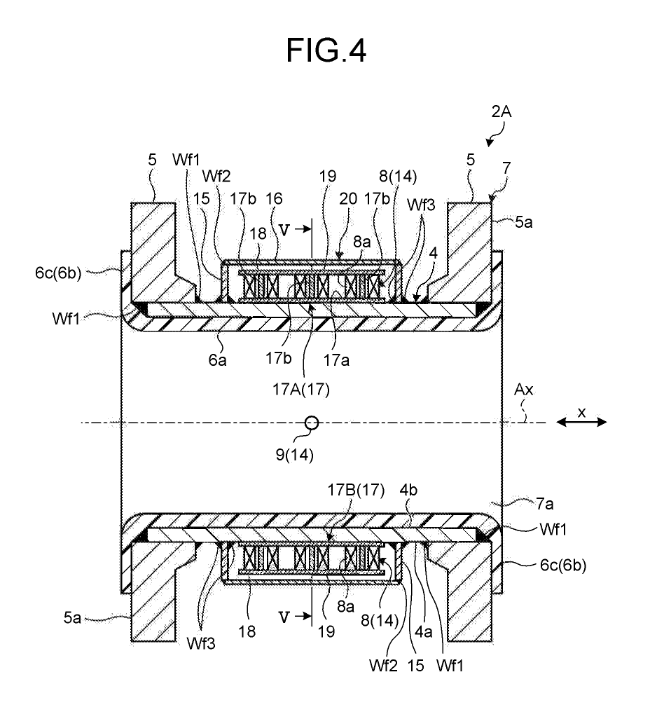

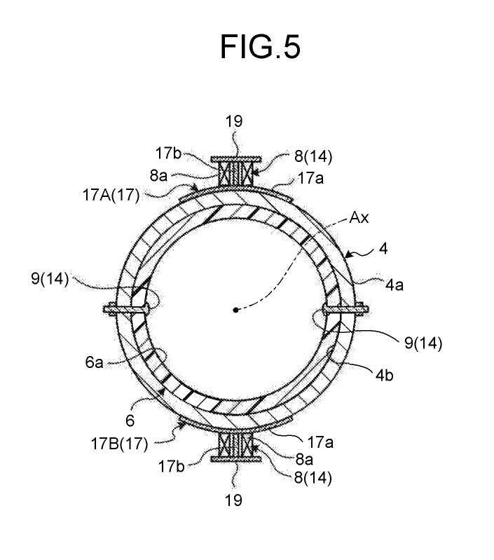

Moreover, in the first embodiment, as an example, the specifications of the coil units 8 are the same as the specifications of the coil units 8 included in a detector 2A of another electromagnetic flowmeter (a detector of a second electromagnetic flowmeter). More particularly, the same (common) coil units 8 are used in both the detector 2 illustrated in FIG. 1 and the detector 2A in FIGS. 4 and 5 that includes the measurement pipe 4 having an outer diameter (bore) about twice as large as that of the detector 2. For example, the coil units 8 of the detector 2 have the same specifications including number of windings, diameter, shape, length, and size as the specifications of the coil units 8 of the detector 2A.

Thus, in the first embodiment, as an example, the detectors 2 and 2A having the measurement pipes 4 with different outer diameters (bores) include the coil units 8 with the same specifications. That is, according to the first embodiment, as an example, for the detectors 2 and 2A (electromagnetic flowmeters) having the measurement pipes 4 with different outer diameters (bores) the use of the common elements (the coil units 8) can be implemented. Hence, as an example, as compared to a conventional configuration including the coil units 8 having different specifications (such as the number of windings or size) according to the outer diameter (bore) of the measurement pipe 4, the manufacturing time and costs for the electromagnetic flowmeter 1 can be easily reduced. Meanwhile, as an example, a plurality of (in the first embodiment, as an example, three) sets of the second portions 17b and the coil units 8 are attached on each base member 17 of the detector 2A with a gap along the axis of the measurement pipe 4. Thus, the detector 2A includes three pairs of coil units 8, 8.

Moreover, in the first embodiment, as an example, as illustrated in FIG. 2, the outer members 19 and the peripheral walls 16 are provided with gaps 18 that extend along the axis (X direction) of the measurement pipe 4. Moreover, in each case 20, at least the peripheral wall 16 is made from a magnetic material such as iron and steel. Hence, the magnetic field (magnetic flux) flows from one of the base members 17 (for example, the first base member 17A) toward the other base member 17 (for example, the second base member 17B) through the measurement pipe 4 and flows into the peripheral wall 16 via the gaps 18. Then, the magnetic field (magnetic flux) flows in the peripheral wall 16 circumferentially and returns to the one base member 17 (for example, the first base member 17A) through the gaps 18. Thus, the peripheral wall 16 forms at least some part of a feedback magnetic path.

As described above, in the first embodiment, as an example, the coil units 8 of the electromagnetic flowmeter 1 (the first electromagnetic flowmeter) have the same specifications as the specifications of the coil units 8 of the detector 2A of another electromagnetic flowmeter (second electromagnetic flowmeter) including the measurement pipe 4 with a different outer diameter (bore). Hence, according to the first embodiment, as an example, the detectors 2 and 2A (electromagnetic flowmeters) having the measurement pipes 4 of different outer diameters (bores) can use the common elements (the con units 8). Hence, as an example, as compared to a conventional configuration including the coil units 8 having different specifications (such as the number of windings or size) according to the outer diameter (bore) of the measurement pipe 4, the manufacturing time and costs for the electromagnetic flowmeter 1 can be easily reduced.

Moreover, in the first embodiment, as an example, each coil unit 8 includes the cylindrical coil 8a. Hence, according to the first embodiment, as an example, as compared to saddle coils attached to the measurement pipes 4 having the same outer diameter (bore), the use of copper wire (the coil 8a) can be decreased. This can further reduce the manufacturing costs of the electromagnetic flowmeter 1, for example.

Furthermore, the first embodiment, as an example, includes the outer members 19 joined with the second portions 17b and the peripheral walls 16 (cover member) made from a magnetic material and located lateral to the outer members 19, opposing the coil units 8 to cover the coil units 8 along the outer face 4a. Hence, according to the first embodiment, as an example, the peripheral walls 16 can function as a feedback magnetic path. Unlike a conventional configuration in which and the feedback magnetic path is directly joined with the second portions 17b, it is made possible to prevent the impact on the peripheral walls 16 from reaching the coil units 8. Hence, as an example, the reliability of the electromagnetic flowmeter 1 can be enhanced. Moreover, as an example, owing to the peripheral walls 16 forming a part of the feedback magnetic paths, the electromagnetic flowmeter 1 can be further downsized from the one including the feedback magnetic path and the peripheral walls 16 as different members, resulting in further reducing the manufacturing time and costs for the electromagnetic flowmeter 1.

In the first embodiment, as an example, the outer members 19 and the peripheral walls 16 (cover members) are disposed with the gaps 18. Hence, according to the present embodiment, as an example, manufacturing variations (dimensional variations) in the cases 20, the base members 17, and the outer members 19 can be eliminated. Hence, as an example, in comparison with no gaps 18 provided, the cases 20, the base members 17, and the outer members 19 can be attached to the measurement pipe 4 by simpler, more smooth, and more accurate work.

Furthermore, in the first embodiment, as an example, sets (in the first embodiment, as an example, two in the detector 2 and three in the detector 2A) of the second portions 17b and the coil units 8 corresponding to the second portions 17b are provided along the axis (X direction) of the measurement pipe 4. Hence, according to the first embodiment, as an example, the generated magnetic field (magnetic flux) can be easily increased inside the measurement pipe 4 through the first portions 17a. Thus, as an example, the electromagnetic flowmeter 1 can more accurately detect the flow rate. Moreover, as an example, in a plurality of detectors 2 and 2A (electromagnetic flowmeters) having the measurement pipes 4 with different outer diameters (bores), the strength (amount) of the generated magnetic field inside the measurement pipe 4 can be relatively easily changed by adjusting the number of common elements (the coil units 8).

Meanwhile, the first embodiment exemplifies the wetted electromagnetic flowmeter 1 in which the pair of electrodes 9 contacts with the fluid to be measured. However, it should not be limited thereto. Alternatively, the electromagnetic flowmeter 1 can be of non-wetted type in which the pair of electrodes 9 does not contact with the fluid to be measured.

Moreover, in the first embodiment, as an example, the coil units 8 are formed by hardening the cylindrically-wound coils 8a by impregnation. Alternatively, self-fusing coils 8a cylindrically wound and hardened can be used for the coil units 8.

### Second Embodiment

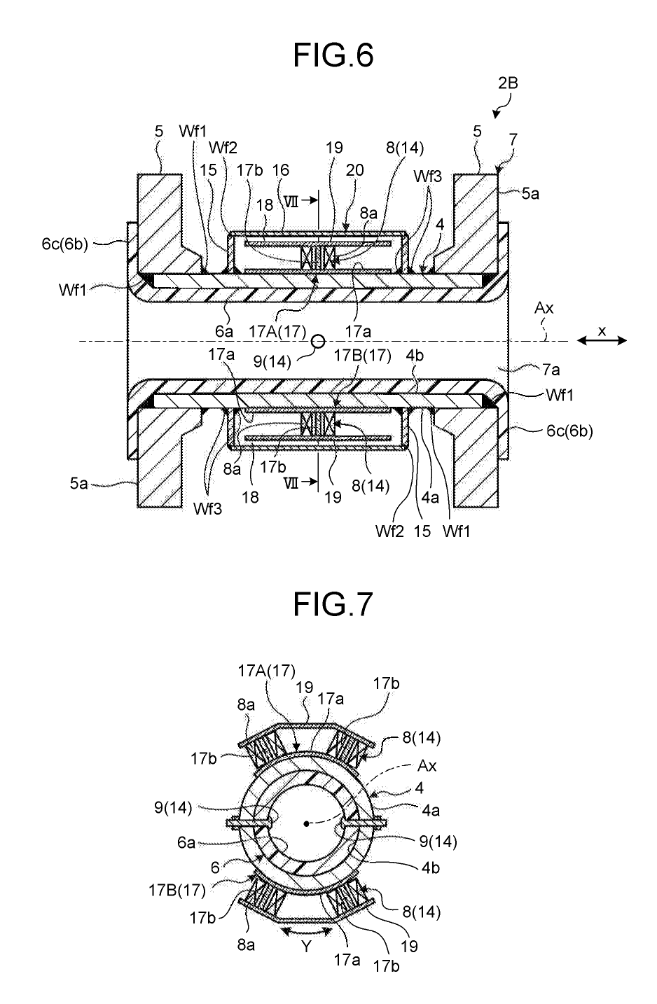

A detector 2B illustrated in FIG. 6 according to a second embodiment has the same configuration as the detector 2 of the electromagnetic flowmeter 1 according to the first embodiment. Hence, the second embodiment can also achieve the same results (effects) based on the same configuration.

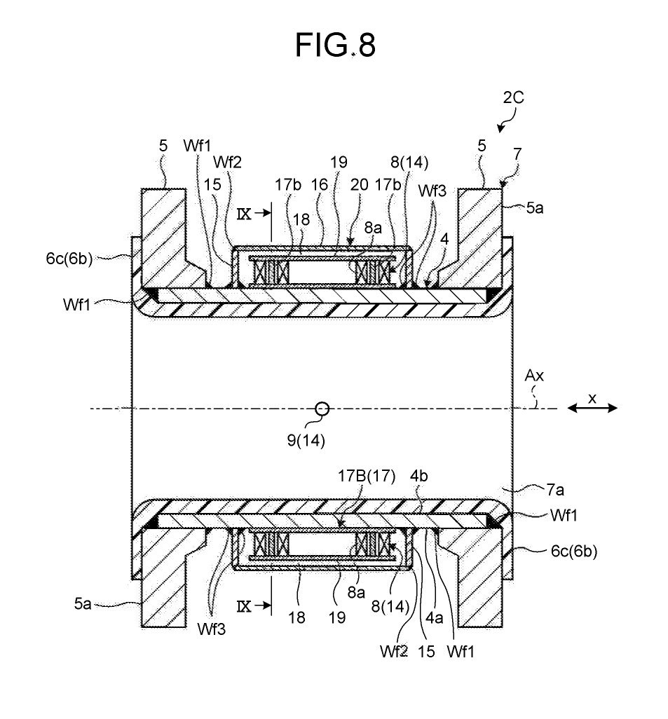

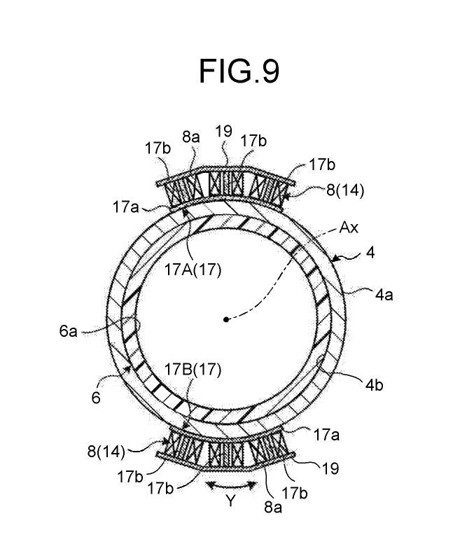

However, in the second embodiment, as an example, as illustrated in FIGS. 6 and 7, the detector 2B (a detector of a third electromagnetic flowmeter) includes a plurality of (in the second embodiment, as an example, two) pairs of coil units 8 arranged along the circumference (Y direction, see FIG. 7) of the measurement pipe 4. Moreover, the coil units 8 have the same specifications as the specifications of the coil units 8 of a detector 2C of another electromagnetic flowmeter (a detector of a fourth electromagnetic flowmeter). More particularly, the same (common) coil units 8 are included in the detector 2B illustrated in FIG. 6 and the detector 2C illustrated in FIGS. 8 and 9 that includes the measurement pipe 4 having the outer diameter (bore) about twice as large as the measurement pipe 4 of the detector 2B as. For example, the coil units 8 of the detector 2B have the same specifications including number of windings, diameter, shape, length, and size as the specifications of the coil units 8 of the detector 2C. Hence, according to the second embodiment, as an example, the detectors 2B and 2C (electromagnetic flowmeters) having the measurement pipes 4 with different outer diameters (bores) can use the common elements (the coil units 8). This, as an example, makes it possible to reduce the manufacturing time and costs for the electromagnetic flowmeters. In the second embodiment, approximately the same strength (amount) of a magnetic field (magnetic flux) as that in the first embodiment can be also generated in the measurement pipe 4 by the coil units 8 arranged along the circumference (Y direction). Moreover, as an example, a plurality of (in the second embodiment, as an example, three) sets of second portions 17b and coil units 8 are attached on the base members 17 of the detector 2C at spacings along the circumference (Y direction, see FIG. 9) of the measurement pipe 4.

Furthermore, in the second embodiment, as an example, in the detector 2C, a plurality of (in the second embodiment, as an example, three) coil units 8 arranged in the circumferential direction (the Y direction, see FIG. 9) are also arranged in plurality (in the second embodiment, as an example, two sets) at intervals in the axis direction (the X direction, see FIG. 8). That is, as an example, the detector 2C includes a total of six pairs of coil units 8, 8.

### Third Embodiment

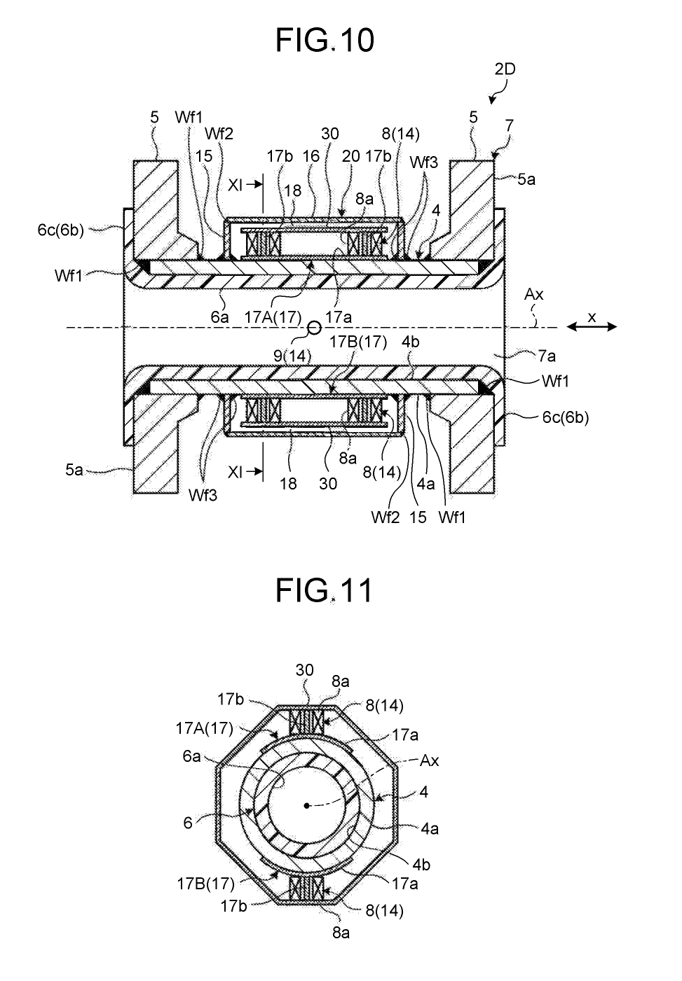

A detector 2D of an electromagnetic flowmeter illustrated in FIG. 10 according to a third embodiment has the same configuration as the detector 2 of the electromagnetic flowmeter 1 according to the first embodiment. Hence, the third embodiment can also achieve the same results (effects) based on the same configuration.

However, in the third embodiment, as an example, as illustrated in FIGS. 10 and 11, the detector 2D (a detector of a fifth electromagnetic flowmeter) includes a plurality of (in the third embodiment, as an example, two) pairs of coil units 8 and a circular member 30 made from a magnetic material. The circular member 30 is placed around the coil units 8, opposing the first portions 17a and is secured (joined) with the second portions 17b by welding or with fasteners, for example. The circular member 30 is one example of a feedback magnetic path. Moreover, the coil units 8 are standardized to have the same specifications as the coil units 8 of other electromagnetic flowmeters. Hence, in the third embodiment, as an example, for electromagnetic flowmeters having the measurement pipes 4 of different outer diameters (bores), the use of common elements (the coil units 8) can be implemented. Hence, as an example, it is possible to easily reduce the manufacturing time and costs for the electromagnetic flowmeters.

### Fourth Embodiment

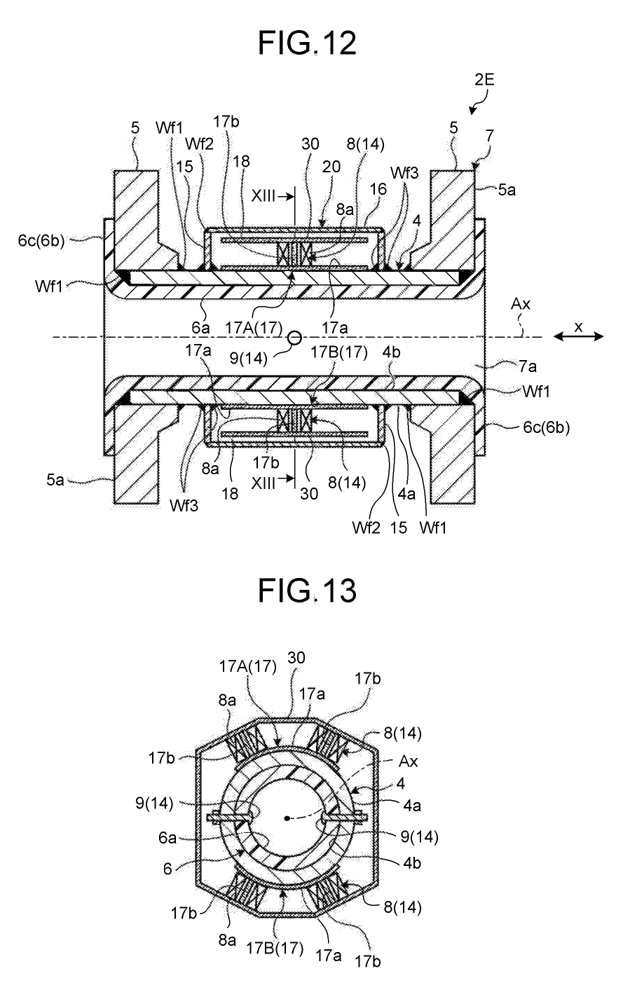

A detector 2E of an electromagnetic flowmeter illustrated in FIG. 12 according to a fourth embodiment has the same configuration as the detector 2B of the electromagnetic flowmeter according to the second embodiment. Hence, the fourth embodiment is also able to achieve the same results (effects) based on the same configuration.

However, in the fourth embodiment, as an example, as illustrated in FIGS. 12 and 13, the detector 2E (a detector of a sixth electromagnetic flowmeter) includes a plurality of (in the third embodiment, as an example, two) pairs of coil units 8 aligned along the circumference (Y direction) and the circular member 30 made from a magnetic material. The circular member 30 is placed around the coil units 8, opposing the first portions 17a and, are secured (joined) with the second portions 17b by welding or with fasteners, for example. The circular member 30 is one example of a feedback magnetic path. Moreover, the coil units 8 are configured to have the same specifications as those of the coil units 8 of other electromagnetic flowmeters Hence, in the fourth embodiment, as an example, for the electromagnetic flowmeters having the measurement pipes 4 with different outer diameters (bores), the use of common elements (the coil units 8) can be implemented. This can accordingly reduce the manufacturing time and costs for the electromagnetic flowmeters, as an example.

While certain embodiments of the invention have been described, the embodiments have been presented by way of example only, and are not intended to limit the scope of the inventions. Indeed, the above embodiments may be embodied in a variety of other forms, and various omissions, substitutions, combinations and changes may be made without departing from the spirit of the invention. The novel embodiments are included in the scope and gist of the invention and included in the invention recited in claims and equivalents thereof . Moreover, regarding the constituent elements, their specifications (structure, type, direction, shape, size, length, width, thickness, height, number, arrangement, position, material, etc.) can be arbitrarily modified.

1. An electromagnetic flowmeter comprising:
a pipe through which a fluid to be measured flows;
a pair of base members each including a first portion and at least one second portion, the pair of base members provided across an axial center of the pipe, the first portion contacting with an outer face of the pipe, the second portion protruding from the first portion toward outside of the pipe radially; and
coil units each including a cylindrical coil the coil units corresponding to the second portions and attached to the base members while the second portions are inserted into pipes of the coils, wherein
the coil units have a same specification as a specification of coil units of another electromagnetic flowmeter that includes the pipe having a different outer diameter.

2. The electromagnetic flowmeter according to claim 1, further comprising:
outer members joined with the second portions and placed lateral to the coil units, opposing the first portions, respectively; and
cover members made from a magnetic material and placed lateral to the outer members, opposing the coil units, to cover the coil units along the outer face.

3. The electromagnetic flowmeter according to claim 2, wherein the outer members and the cover members are disposed with gaps.

4. An electromagnetic flowmeter comprising:
a pipe through which a fluid to be measured flows;
a pair of base members each including a first portion and at least one second portion, the pair of base members provided across an axial center of the pipe, the first portion contacting with an outer face of the pipe, the second portions protruding from the first portion toward outside of the pipe radially;
coil units each including a cylindrical coil, the coil units corresponding to the second portions and attached to the base members while the second portions are inserted into pipes of the coils;
outer members joined with the second portions and placed lateral to the coil units, opposing the first portions, respectively; and
cover members made from a magnetic material and placed lateral to the outer members, opposing the coil units, to cover the coil units along the outer face.

5. The electromagnetic flowmeter according to claim 4, wherein the outer members and the cover members are disposed with gaps.

6. The electromagnetic flowmeter according to claim 1, wherein a plurality of sets of the second portions and the coil units corresponding to the second portions are provided in plurality along an axis of the pipe.

7. The electromagnetic flowmeter according to claim 1, wherein a plurality of sets of the second portions and the coil units corresponding to the second portions are provided art plurality along a circumference of the pipe.
